(19) United States
(12) Patent Application Publication
(10) Pub. No.: US 2014/0166915 A1
(43) Pub. Date: Jun. 19, 2014

(54) ELECTROMAGNETIC VALVE DEVICE FOR HIGH-PRESSURE FLUID

(71) Applicant: DENSO CORPORATION, Kariya-city (JP)

(72) Inventors: Ryo ISHIBASHI, Anjo-city (JP); Akira TAKAGI, Obu-city (JP)

(73) Assignee: DENSO CORPORATION, Kariya-city (JP)

(21) Appl. No.: 14/090,394

(22) Filed: Nov. 26, 2013

(30) Foreign Application Priority Data
Nov. 27, 2012 (JP) 2012-258241

(51) Int. Cl. F16K 31/06

(52) U.S. Cl. CPC F16K 31/0675
USPC 251/129.15

(57) ABSTRACT

A movable core sliding in a guide portion includes a small outer-diameter part, a large outer-diameter part, and a protrusion part. When a magnetic circuit is generated by energizing a coil, a magnetic attractive force inclining with respect to a center axis of the guide portion is generated between the guide portion and the movable core, and moves the movable core towards a stator core. Then, a sliding portion, which is provided over the whole periphery of the small outer-diameter part, and the protrusion part of the movable core are abutted on an inner peripheral surface of the guide portion, a clearance is generated between an outer peripheral surface of parts of the movable core except the protrusion part and the inner peripheral surface of the guide portion. Since the valve member can be opened by a small magnetic attractive force, a coil assembly can be made small.

### CROSS-REFERENCE TO RELATED APPLICATION

This application is based on Japanese Patent Application No. 2012-258241 filed on Nov. 27, 2012, the disclosure of which is incorporated herein by reference.

### TECHNICAL FIELD

The present disclosure relates to an electromagnetic valve device for a high-pressure fluid, which blocks or allows a flow of the high-pressure fluid by using an electromagnetic valve.

### BACKGROUND

It is known that a gaseous fuel supplying system depressurizes a pressure of a gaseous fuel supplied to an internal combustion engine from a high-pressure in a fuel tank to a low-pressure so that an injector for the gaseous fuel is capable of injecting the gaseous fuel. Hereafter, the internal combustion engine is referred to as an engine. An electromagnetic valve device for the gaseous fuel is provided in the gaseous fuel supplying system. The electromagnetic valve device for the gaseous fuel includes a valve driving portion and a valve member portion. The valve driving portion is constructed by a coil which generates magnetic force by energization, a stator core, a movable core, and a guide portion which slidably receives the movable core. The valve member is constructed by a valve member moving integrally with the movable core, and a valve seat. The electromagnetic valve device for the gaseous fuel cuts off a flow of the gaseous fuel of high-pressure to prevent the gaseous fuel of high-pressure from flowing into the injector for the gaseous fuel.

The electromagnetic valve device for the gaseous fuel has a self-seal function which improves an air tightness between the valve member and the valve seat by using the pressure of the gaseous fuel supplied by the fuel tank. Therefore, the guide portion of the electromagnetic valve device for the gaseous fuel is filled with the gaseous fuel of high-pressure so that the valve member is biased in a valve closing direction. Further, the guide portion has a pressure resistant to prevent a leak of the gaseous fuel.

When the valve member separates from the valve seat, a magnetic attractive force repelling the pressure of the gaseous fuel in the guide portion is generated between the movable core and the stator core. Therefore, a diameter of the movable core is relatively increased.

In the electromagnetic valve device for, the gaseous fuel, since the guide portion slidably receives the movable core having a large-diameter and has to be pressure resistant, the guide portion has a wall thickness thicker than that of the guide portion in which the high-pressure fluid is not fully filled. Generally, when a wall thickness of a guide portion made of a non-magnetic material becomes thicker, the magnetic attractive force generated relative to a value of a current flowing through the coil becomes smaller. To increase the magnetic attractive force between the movable core and the stator core, the current may be increased, or a number of reels of the coil may be increased. However, when the current is increased, an energy consumption amount is increased. When the number of reels of the coil is increased, a size of the electromagnetic valve device becomes larger.

Japanese Patent No. 4871207 discloses a high-pressure electromagnetic valve having a magnetic field auxiliary member provided on a part of a guide portion radially outside of the guide portion. Further, the magnetic field auxiliary member is made of a magnetic material, and the guide portion is made of a non-magnetic material. JP-2011-108781A discloses a linear solenoid having a magnetism blocking portion for transferring magnetism from a space between the linear solenoid and a plunger to a stator core. Further, the stator core is made of a magnetic material and slidably receives the plunger.

However, in the high-pressure electromagnetic valve disclosed in Japanese Patent No. 4871207, since the guide portion is made of a non-magnetic material, the magnetic attractive force generated relative to the value of the current flowing through the coil cannot be increased large enough. Therefore, the size of the electromagnetic valve device becomes larger. Further, since the magnetic field auxiliary member is provided as another part, a number of parts is increased. Therefore, a cost of attachment is increased.

Since the linear solenoid disclosed in JP-2011-108781A is used to switch a flow of an operating fluid of relatively low-pressure at an operating pressure range, a leakage of oil as the operating fluid is allowed, and the linear solenoid has no self-seal function.

Therefore, the linear solenoid disclosed in JP-2011-108781A cannot be used in the electromagnetic valve device for the high-pressure fluid.

### SUMMARY

It is an object of the present disclosure to provide an electromagnetic valve device for a high-pressure fluid, in which a flow of the high-pressure fluid is blocked or allowed, and the electromagnetic valve device can be miniaturized. According to an aspect of the present disclosure, an electromagnetic valve device for a high-pressure fluid includes a coil assembly, a stator core, a movable core, a guide portion, a protrusion part, a valve member, and a seat member. The coil assembly generates a magnetic force when being energized. The stator core is made of a magnetic material, and is excited when the coil assembly generates the magnetic force. The movable core is made of a magnetic material, and is moved to the stator core when the coil assembly generates the magnetic force. The guide portion slidably receives the movable core and is filled with the high-pressure fluid. The guide portion includes a magnetism blocking portion that blocks a magnetic flux over the whole periphery of a predetermined position in an axial direction of the guide portion, and a magnetism passing portion through which the magnetic flux passes. The protrusion part is provided on an outer peripheral surface of the movable core. The protrusion part slides on an inner peripheral surface of the guide portion in a case where the movable core slides in the guide portion. The valve member is connected with the stator core. The seat member forms a valve seat abutting on or separating from the valve member to block or allow the flow of the high-pressure fluid. Further, when the coil assembly generates the magnetic force, a magnetic circuit bypassing the magnetism blocking portion is generated between the magnetism passing portion of the guide portion and the movable core.

In the electromagnetic valve device for the high-pressure fluid, the movable core is moved to the stator core by the magnetic circuit generated by energizing the coil assembly. In this case, the magnetic circuit is generated between the stator core and the movable core and between the magnetism passing portion of the guide portion and the movable core. The magnetic circuit is generated between the magnetism passing portion and the movable core which are relatively readily for the magnetic flux to pass through, and is generated to incline with respect to a center axis of the guide portion and to bypass the magnetism blocking portion which is readily magnetically saturated because the magnetic flux relatively difficultly passes through. The magnetic circuit generates an electromagnetic attractive force to move the movable core to the stator core. The movable core is moved to the stator core by not only the magnetic attractive force generated according to the magnetic circuit between the stator core and the movable core but also the magnetic attractive force generated according to the magnetic circuit between the magnetism passing portion and the movable core.

Therefore, comparing to the movable core moved only by the magnetic attractive force generated according to the magnetic circuit between the stator core and the movable core, a facing area of the movable core relative to the stator core can be made smaller, and a diameter of the movable core can be made smaller. Thus, a size of the electromagnetic valve device for the gaseous fuel can be made small.

Further, since the diameter of the movable core of the electromagnetic valve device for the high-pressure fluid becomes small, a diameter of the guide portion slidably receiving the movable core becomes small. When the diameter of the guide portion is decreased, a pressure resistance of the guide portion repelling a pressure of the gaseous fuel filled in the guide portion is improved.

Therefore, in a case where the high-pressure fluids with the same pressure are filled, comparing to the electromagnetic valve device for the high-pressure fluid having the movable core moved only by the magnetic attractive force generated according to the magnetic circuit between the stator core and the movable core, a wall thickness of the guide portion can be made thinner. Thus, the size of the electromagnetic valve device for the gaseous fuel can be made further small. Since the protrusion part is provided on the outer peripheral surface of the movable core, when the movable core slides in the guide portion, the protrusion part slides on the inner peripheral surface of the guide portion, and a frictional resistance between the movable core and the guide portion is less than that of when the whole outer peripheral surface of the movable core slides on the inner peripheral surface of the guide portion. Further, since the protrusion part is provided, among other parts of the movable core except the protrusion part, a clearance is generated between the outer peripheral surface of the movable core and the inner peripheral surface of the guide portion. Therefore, a magnetic attractive force corresponding to a magnetic side force, which is generated in a direction perpendicular to a center axis of the guide portion, becomes relatively small. An eccentricity rate of the movable core relative to the guide portion becomes small, and a frictional resistance of when the movable core slides in the guide portion becomes small. Thus, the valve member can be opened at a small attractive force, and a performance at a low voltage is improved. The coil assembly can be made small, and the size of the electromagnetic valve device for the gaseous fuel can be made further small.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing an outline of a gaseous fuel supplying system to which an electromagnetic valve device for a gaseous fuel is applied, according to a first embodiment of the present disclosure;

FIG. 2 is a sectional view showing the electromagnetic valve device for the gaseous fuel, according to the first embodiment;

FIG. 3 is an enlarged view of a part of the electromagnetic valve device for the gaseous fuel shown in FIG. 2;

FIG. 4 is a sectional view showing the electromagnetic valve device for the gaseous fuel in a different operation from FIG. 2, according to the first embodiment;

FIG. 5 is a sectional view showing the electromagnetic valve device for the gaseous fuel in a different operation from FIG. 2 or 4, according to the first embodiment;

FIG. 6 is a sectional view showing the electromagnetic valve device for the gaseous fuel, according to a second embodiment of the present disclosure.

FIG. 7 is a sectional view showing the electromagnetic valve device for the gaseous fuel, according to a third embodiment of the present disclosure; and

FIG. 8 is a sectional view showing the electromagnetic valve device for the gaseous fuel, according to a fourth embodiment of the present disclosure.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereafter, embodiments of the present disclosure will be described with reference to drawings.

### First Embodiment

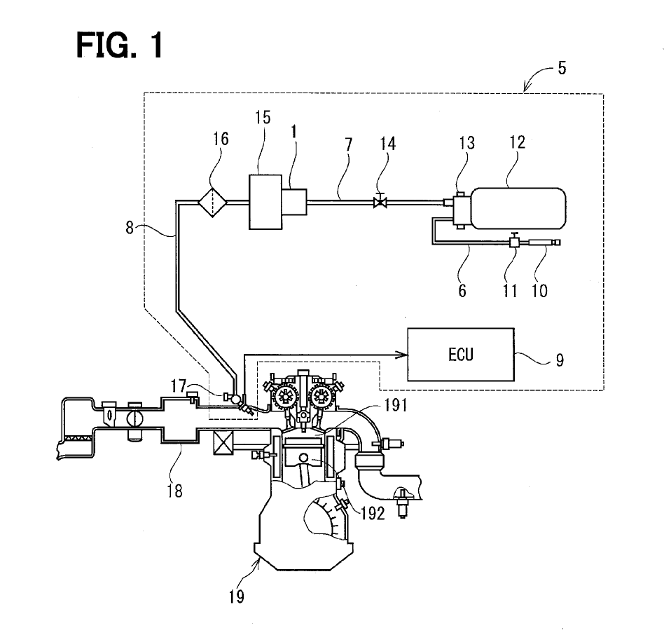

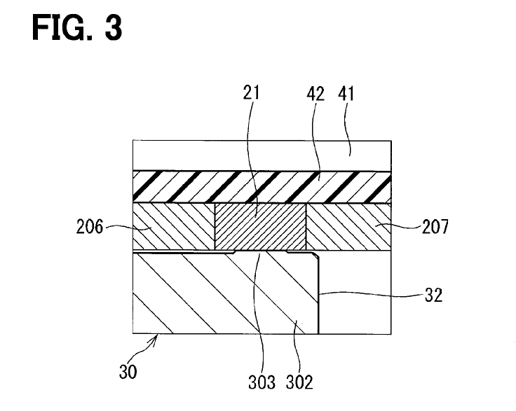

Referring to FIGS. 1 to 5, an electromagnetic valve device 1 for a gaseous fuel according to a first embodiment of the present disclosure will be detailed.

First, a gaseous fuel supplying system to which the electromagnetic valve device 1 is applied will be described with reference to FIG. 1. The gaseous fuel supplying system 5, for example, is mounted to a vehicle using a compressed natural gas as fuel. The gaseous fuel supplying system 5 includes a gas inlet 10, a fuel tank 12, the electromagnetic valve device 1, a pressure control valve 15 for the gaseous fuel, an injector 17 for the gaseous fuel, and an electrical control unit 9. According to the present disclosure, the injector 17 corresponds to an injection portion.

The gaseous fuel of high-pressure is supplied from external to the gas inlet 10, and is introduced into and stored in the fuel tank 12 via a supply pipe 6. The gas inlet 10 has a back-flow preventing function to control the gaseous fuel so that the gaseous fuel supplied from the gas inlet 10 does not backflow to external. The supply pipe 6 is provided with a gas filling valve 11.

The fuel tank 12 is provided with a fuel tank valve 13. The fuel tank valve 13 has a back-flow prevention function, an excess flow prevention function, and a pressurization prevention function. The back-flow prevention function of the fuel tank valve 13 is for preventing the gaseous fuel from back-flowing from the fuel tank 12 to the gas inlet 10. The excess flow prevention function is for blocking a flow of the gaseous fuel from the fuel tank 12 in a case where a flow amount of the gaseous fuel flowing through a supply tube 7 is greater than or equal to a predetermined amount. The pressurization prevention security function is for preventing a damage of the fuel tank 12 by opening the fuel tank 12 to external in a case where a pressure in the fuel tank 12 is increased.

The fuel tank valve 13 is connected with the electromagnetic valve device 1 via the supply tube 7. The supply tube 7 is provided with a master valve 14 capable of manually blocking the supply tube 7.

The electromagnetic valve device 1 is placed at a position upstream of the pressure control valve 15. That is, the electromagnetic valve device 1 is positioned between the pressure control valve 15 and the fuel tank 12. When a pressure of the gaseous fuel flowing downstream of the pressure control valve 15 is greater than or equal to a predetermined pressure, the electromagnetic valve device 1 blocks the flow of the gaseous fuel introduced into the pressure control valve 15 according to a command of the ECU 9. The electromagnetic valve device 1 blocks or allows a flow of the gaseous fuel by an electromagnetic valve which is not shown.

The pressure control valve 15 depressurizes the pressure of the gaseous fuel supplied from the supply tube 7 to a pressure so that the injector 17 is capable of injecting the gaseous fuel. For example, the pressure control valve 15 depressurizes a high-pressure of the gaseous fuel in the fuel tank 12 to a low-pressure so that the injector 17 is capable of injecting the gaseous fuel. In this case, the high-pressure is 20 MPa, and the low-pressure is within a pressure range from 0.2 MPa to 0.65 MPa.

In the gaseous fuel depressurized by the pressure control valve 15, oil is removed by an oil filter 16. Then, the gaseous fuel is supplied to the injector 17 via a supply duct 8. The injector 17 injects the gaseous fuel into an intake pipe 18 according to an indication of the ECU 9 which is electrically connected with the injector 17. The injector 17 is provided with a temperature sensor and a pressure senor which are not shown. A temperature of the gaseous fuel and the pressure of the gaseous fuel which are detected by the temperature sensor and the pressure sensor, respectively, are outputted to the ECU 9.

The gaseous fuel injected into the intake pipe 18 is mixed with an air introduced from the atmosphere. Then, a mixed gas is introduced into a cylinder 191 from an intake port of an engine 19. In this case, the mixed gas is the gaseous fuel mixed with the air, and the engine 19 is connected with the intake pipe 18 and is used as an internal combustion engine. In the engine 19, a rotational torque is generated by a compression and a combustion of the mixed gas according to a lifting of a piston 192. The mixed gas is the gaseous fuel mixed with the air.

The gaseous fuel supplying system 5 depressurizes the pressure of the gaseous fuel in the fuel tank 12 to the pressure so that the injector 17 is capable of injecting the gaseous fuel, and supplies the gaseous fuel to the engine 19 by the injector 17.

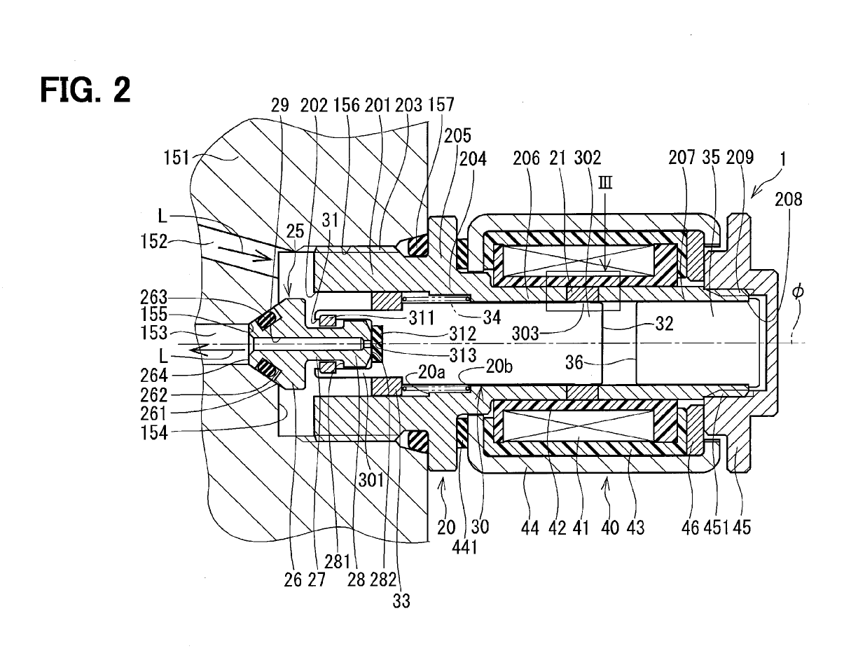

Next, a configuration of the electromagnetic valve device 1 according to the first embodiment will be described with reference to FIGS. 2 to 5. Further, solid arrows L shown in FIGS. 2 to 4 indicate flow directions of the gaseous fuel.

According to the first embodiment, the electromagnetic valve device 1 is constructed by a support member 151, a valve seat 155, a guide portion 20, a valve member 25, a movable core 30, a sliding portion 33, a stator core 35, a coil assembly 40 and a cover portion 45.

The support member 151 includes an inlet passage 152, an outlet passage 153, and a concave portion 154. The concave portion 154 communicates with the inlet passage 152 and the outlet passage 153. The gaseous fuel in the fuel tank 12 is supplied to the inlet passage 152 via the supply tube 7. The gaseous fuel is exhausted from the outlet passage 153 towards the pressure control valve 15. The concave portion 154 is provided so that the concave portion 154 has an opening on an outer wall of the support member 151. Further, an internal-screw groove 156 is provided in the inner wall of the concave portion 154 which is substantially perpendicular to the outer wall of the support member 151. The internal-screw groove 156 is for screwing the guide portion 20.

The valve seat 155 is a part of an inner wall of the concave portion 154 of the support member 151, and is taper-shaped so that the valve seat 155 is inclined from the concave portion 154 to the outlet passage 153. According to the present embodiment, the support member 151 corresponds to a seat member. The support member 151 forming the valve seat 155 abutting on or separating from the valve member 25 to block or allow the flow of the high-pressure fluid.

Further, in the electromagnetic valve device 1 according to the first embodiment, the support member 151 corresponds to a valve body of the pressure control valve 15 connected with a downstream end of the electromagnetic valve device 1. It is not limited to the above configuration. For example, the support member 151 may be provided as another part different from the valve body of the pressure control valve 15.

The guide portion 20 is supported by the support member 151. The guide portion 20 slidably receives the movable core 30 in an axial direction of the guide portion 20. The guide portion 20 is provided to be filled with and not to leak the gaseous fuel of high-pressure from the inlet passage 152 to the outlet passage 153 via the concave portion 154.

The guide portion 20 is constructed by a large-diameter portion 201, a medium-diameter portion 204, a ring portion 205, a first small-diameter portion 206, a magnetism blocking portion 21, and a second small-diameter portion 207, from the support member 151. In the guide portion 20 of the electromagnetic valve device 1 according to the first embodiment, the large-diameter portion 201, the medium-diameter portion 204, the ring portion 205, the first small-diameter portion 206, the magnetism blocking portion 21 and the second small-diameter portion 207 are integrally bonded to each other.

In addition, among the guide portion, the large-diameter portion 201, the medium-diameter portion 204, the ring portion 205, the first small-diameter portion 206 and the second small-diameter portion 207 are made of a magnetic material, such as a magnetic stainless steel including chromium from 13 wt % to 17 wt %.

The large-diameter portion 201 is substantially tube-shaped and has a first inner diameter and a first outer diameter which are predetermined. A first end part of the large-diameter portion 201 has an opening 202 and an external-screw groove 203. The movable core 30 or the valve member 25 slides into or out of the guide portion 20, through the opening 202. The external-screw groove 203 is screwed with the internal-screw groove 156 of the support member 151.

The medium-diameter portion 204 is substantially tube-shaped and has a second outer diameter less than the first outer diameter of the large-diameter portion 201. A first end part of the medium-diameter portion 204 is connected with a second end part of the large-diameter portion 201. An area of the medium-diameter portion 204 which is connected with the large-diameter portion 201 has a second inner diameter less than the first inner diameter of the large-diameter portion 201. An area of the medium-diameter portion 204 which is connected with the second inner diameter has a third inner diameter less than the second inner diameter.

A first step side surface 20a is provided on a border between an inner peripheral surface of the first inner diameter of the large-diameter portion 201 and an inner peripheral surface of the second inner diameter of the medium-diameter portion 204. A second step side surface 20b is provided on a border between the inner peripheral surface of the second inner diameter of the medium-diameter portion 204 and an inner peripheral surface of the third inner diameter of the medium-diameter portion 204. According to the present embodiment, the first step side surface 20a corresponds to a first step surface, and the second step side surface 20b corresponds to a third step surface.

The ring portion 205 is provided radially outside of the medium-diameter portion 204, and has an outer diameter greater than the first outer diameter of the large-diameter portion 201. When the guide portion 20 is attached to the support member 151, or when the guide portion 20 is detached from the support member 151, a rotational torque is applied to the ring portion 205 by tools. A seal member 157 is provided between the ring portion 205 and the support member 151 so as to prevent the gaseous fuel from being leaked from the concave portion 154.

The first small-diameter portion 206 is substantially tube-shaped, has a third outer diameter less than the second outer diameter of the medium-diameter portion 204, and has a third inner diameter equal to the third inner diameter of the medium-diameter portion 204. A first end part of the first small-diameter portion 206 is connected with a second end part of the medium-diameter portion 204. According to the present embodiment, the first small-diameter portion 206 corresponds to a magnetism passing portion.

The magnetism blocking portion 21 is substantially tube-shaped, has a third outer diameter equal to the third outer diameter of the first small-diameter portion 206, and has a third inner diameter equal to the third inner diameter of the first small-diameter portion 206. A first end part of the magnetism blocking portion 21 is connected with a second end part of the first small-diameter portion 206. Since the magnetism blocking portion 21 is made of a non-magnetic material modified by a reformulation operation from a magnetic stainless steel including chromium, it is difficult for a magnetic flux generated by energizing a coil 41 to pass through the magnetism blocking portion 21, and the magnetism blocking portion 21 is readily magnetically saturated.

The second small-diameter portion 207 is substantially tube-shaped, has a third outer diameter equal to the third outer diameter of the magnetism blocking portion 21, and has a third inner diameter equal to the third inner diameter of the magnetism blocking portion 21. The second small-diameter portion 207 has a first end part connected with a second end part of the magnetism blocking portion 21, and a second end part having a port 208 and an external-thread groove 209. Therefore, the second small-diameter portion 207 is arranged at a position closer to the stator core 35 than the magnetism blocking portion 21.

The port 208 is a member for fixing the stator core 35. The external-thread groove 209 is provided radially outside of the second small-diameter portion 207. The external-thread groove 209 is a member for screwing the cover portion 45. According to the present embodiment, the second small-diameter portion 207 corresponds to the magnetism passing portion.

Considering a size of an inner diameter of the guide portion 20, the large-diameter portion 201 has the first inner diameter, the area of the medium-diameter portion 204 which is connected with the large-diameter portion 201 has the second inner diameter, and the area of the medium-diameter portion 204 which is connected with the first small-diameter portion 206, the first small-diameter portion 206, the magnetism blocking portion 21 and the second small-diameter portion 207 have the third inner diameter.

According to the present embodiment, the area of the medium-diameter portion 204 which is connected with the first small-diameter portion 206, the first small-diameter portion 206, the magnetism blocking portion 21 and the second small-diameter portion 207 correspond to a small inner-diameter part. The area of the medium-diameter portion 204 which is connected with the large-diameter portion 201 corresponds to a medium inner-diameter part. The large-diameter portion 201 corresponds to a large inner-diameter part.

The valve member 25 is constructed by a contact portion 26, a small-radius portion 27, and a large-radius portion 28. The contact portion 26, the small-radius portion 27 and the large-radius portion 28 which are made of a non-magnetic material are integrally bonded to each other. The valve member 25 is abutting on or separating from the valve seat 155, according to a sliding movement of the movable core 30.

The contact portion 26 which is a truncated-cone shape has an incline surface 261 capable of abutting on or separating from the valve seat 155. The incline surface 261 has a receiving chamber 262. The receiving chamber 262 which is ring-shaped has a concave shape in a sectional view. The receiving chamber 262 receives a seal portion 263. When the incline surface 261 is abutted on the valve seat 155, the seal portion 263 holds an airtight state between the concave portion 154 and the outlet passage 153.

The small-radius portion 27 has a first end part connected with a first end part of the contact portion 26 opposite to the incline surface 261. The small-radius portion 27 has an outer diameter which is less than the maximum outer diameter of the contact portion 26 and an outer diameter of the large-radius portion 28.

The large-radius portion 28 has a first end part which is connected with a second end part of the small-radius portion 27 opposite to the first end part of the small-radius portion 27 connected with the contact portion 26. A third step side surface 281 is provided at the first end part of the large-radius portion 28 connected with the small-radius portion 27. A tip surface 282 capable of abutting on a seal element 312 is provided at a second end part of the large-radius portion 28 opposite to the third step side surface 281.

The valve member 25 is further provided with a through hole 29 penetrating the contact portion 26, the small-radius portion 27 and the large-radius portion 28 in an axial direction of the valve member 25. Openings of the through hole 29 are defined by both an edge surface 264 positioned at a second end part of the contact portion 26 opposite to the first end part of the contact portion 26 connected with the small-radius portion 27 and the tip surface 282 of the large-radius portion 28.

The movable core 30, which is made of a magnetic material such as a magnetic stainless steel, is constructed by a small outer-diameter part 301, a large outer-diameter part 302, and a protrusion part 303. The small outer-diameter part 301, the large outer-diameter part 302, and the protrusion part 303 are received in the guide portion 20. In the movable core 30 of the electromagnetic valve device 1 according to the first embodiment, the small outer-diameter part 301, the large outer-diameter part 302, and the protrusion part 303 are integrally bonded to each other.

The small outer-diameter part 301 is a rod-shaped member having a predetermined outer diameter. An outer peripheral surface of the small outer-diameter part 301 is arranged at a position corresponding to the inner peripheral surface of the large-diameter portion 201 of the guide portion 20. A first end part of the small outer-diameter part 301 is provided with a concave part 31.

The concave part 31 receives a part of the small-radius portion 27 of the valve member 25, and the large-radius portion 28 of the valve member 25. In this case, an inner wall of the concave part 31 and an outer wall of the large-radius portion 28 of the valve member 25 define a gap. A limit member 311 is ring-shaped and is provided on an inner wall of a tip part of the concave part 31. When the valve member 25 moves in a direction separating the valve member 25 from a bottom surface of the concave part 31 of the small outer-diameter part 301, the limit member 311 is abutted on the third step side surface 281 of the valve member 25. Therefore, a distance of the valve member 25 relatively moving with respect to the movable core 30 is limited. The valve member 25 is indirectly connected with the movable core 30 via the limit member 311. A receiving chamber 313 receiving the seal element 312 is provided at the bottom surface of the concave part 31.

The large outer-diameter part 302 is a rod-shaped member having an outer diameter greater than that of the small outer-diameter part 301. An outer peripheral surface of the large outer-diameter part 302 is arranged at a position corresponding to an inner peripheral surface of members from the large-diameter portion 201 of the guide portion 20 to the second small-diameter portion 207 of the guide portion 20. A first end part of the large outer-diameter part 302 is connected with a second end part of the small outer-diameter part 301 opposite to the first end part provided with the concave portion. A second end part of the large outer-diameter part 302 opposite to the first end part connected with the small outer-diameter part 301 is provided with an end surface 32.

The protrusion part 303 is provided in the vicinity of the end surface 32 of the large outer-diameter part 302 and is ring-shaped over the whole periphery of the large outer-diameter part 302. Further, the protrusion part 303 is arranged at a position corresponding to an inner peripheral surface of the magnetism blocking portion 21 of the guide portion 20. A thickness and width of the protrusion part 303 are provided so that an outer peripheral surface of the protrusion part 303 slides on the inner peripheral surface of the magnetism blocking portion 21 in a case where the movable core 30 slides in the guide portion 20 in the axial direction of the movable core 30. Therefore, the outer peripheral surface of the large outer-diameter part 302 and the inner peripheral surface of both the first small-diameter portion 206 and the second small-diameter portion 207 define a gap. The outer peripheral surface of the protrusion part 303 is provided with a plating film having a high abrasion resistance which is made of a non-magnetic material.

The sliding portion 33 ring-shaped over the whole periphery of the small outer-diameter part 301 is provided at a position adjacent to a step surface of a border between the small outer-diameter part 301 of the movable core 30 and the large outer-diameter part 302 of the movable core 30. In this case, the position adjacent to a step surface of a border between the small outer-diameter part 301 and the large outer-diameter part 302 closer to the valve member 25 than the protrusion part 303. The sliding portion 33 is made of a non-magnetic material. A thickness and width of the sliding portion 33 is provided so that an outer peripheral surface of the sliding portion 33 slides on the inner peripheral surface of the large-diameter portion 201 of the guide portion 20 in a case where the movable core 30 slides in the guide portion 20 in the axial direction of the movable core 30. The plating film having the high abrasion resistance which is made of a non-magnetic material is provided on the outer peripheral surface of the sliding portion 33.

An end surface of the sliding portion 33 close to the large outer-diameter part 302 faces the step surfaces 20a, 20b of the guide portion 20. A spring 34 is provided between the end surface of the sliding portion 33 close to the large outer-diameter part 302 and the second step side surface 20b of the guide portion 20. The spring 34 corresponding to a third biasing member generates a biasing force to separate the sliding portion 33 from the second step side surface 20b of the guide portion 20 and to bias the movable core 30 towards the valve seat 155.

Further, when the movable core 30 slides in the guide portion 20 in the axial direction of the movable core 30, the end surface of the sliding portion 33 close to the large outer-diameter part 302 abuts on the first step side surface 20a of the guide portion 20 so that a distance of the movable core 30 sliding in a direction opposite to the valve seat 155 is limited. According to the present embodiment, the distance of the movable core 30 corresponds to a moving amount. That is, the first step side surface 20a of the guide portion 20 functions as a stopper relative to a movement of the movable core 30 towards the direction opposite to the valve seat 155.

The stator core 35 is a rod-shaped member made of a magnetic material, and is fixed in the port 208 of the second small-diameter portion 207 of the guide portion 20. A margin surface 36 of a first end part of the stator core 35 is arranged opposite to the end surface 32 of the movable core 30.

The coil assembly 40 is provided to surround a part of the medium-diameter portion 204 of the guide portion 20, the first small-diameter portion 206 of the guide portion 20, the magnetism blocking portion 21 of the guide portion 20, and the second small-diameter portion 207 of the guide portion 20, in a direction radially outside of the guide portion 20. The coil assembly 40 is constructed by the coil 41, a bobbin 42, a cover 43, and a yoke 44.

The coil 41 generates a magnetic field around the coil 41 according to a current supplied via a connector.

The bobbin 42 and the cover 43 are non-magnetic members which are provided to cover the coil 41. The yoke 44 which is made of a magnetic material is provided radially outside of the bobbin 42 and the cover 43. The yoke 44 is crimped at both end parts to receive the coil 41, the bobbin 42 and the cover 43.

An elastic member 441 is provided between the yoke 44 and the ring portion 205. The elastic member 441 biases the coil assembly 40 in a direction separating the coil assembly 40 from the ring portion 205.

The cover portion 45 which is tube-shaped is a metal member having a bottom. An internal-thread groove 451 is provided on an inner wall of the cover portion 45. The internal-thread groove 451 is screwed with the external-thread groove 209 of the second small-diameter portion 207 of the guide portion 20 so that the cover portion 45 is attached to the second small-diameter portion 207 of the guide portion 20.

A spacer 46 made of a non-magnetic material is provided between the cover portion 45 and the coil assembly 40. The elastic member 441 provided between the yoke 44 and the ring portion 205 separates the coil assembly 40 from the ring portion 205, and biases the coil assembly 40 to press the cover portion 45 via the spacer 46. That is, the elastic member 441 functions to stably hold the coil assembly 40 between the ring portion 205 of the guide portion 20 and the cover portion 45.

Next, an operation and effects of the electromagnetic valve device 1 according to the first embodiment will be described with reference to FIGS. 2 to 5.

When the current does not flow through the coil 41 of the electromagnetic valve device 1, only the biasing force of the spring 34 is applied to the movable core 30, thereby biasing the movable core 30 in a separating direction separating the movable core 30 from the stator core 35. Further, the concave portion 154 communicates with the inlet passage 152, and the concave portion 154 is filled with the gaseous fuel of high-pressure. Then, the tip surface 282 of the valve member 25 is abutted on the seal element 312, and the incline surface 261 of the valve member 25 supported by the movable core 30 is abutted on the valve seat 155. Thus, the inlet passage 152 is blocked from communicating with the outlet passage 153.

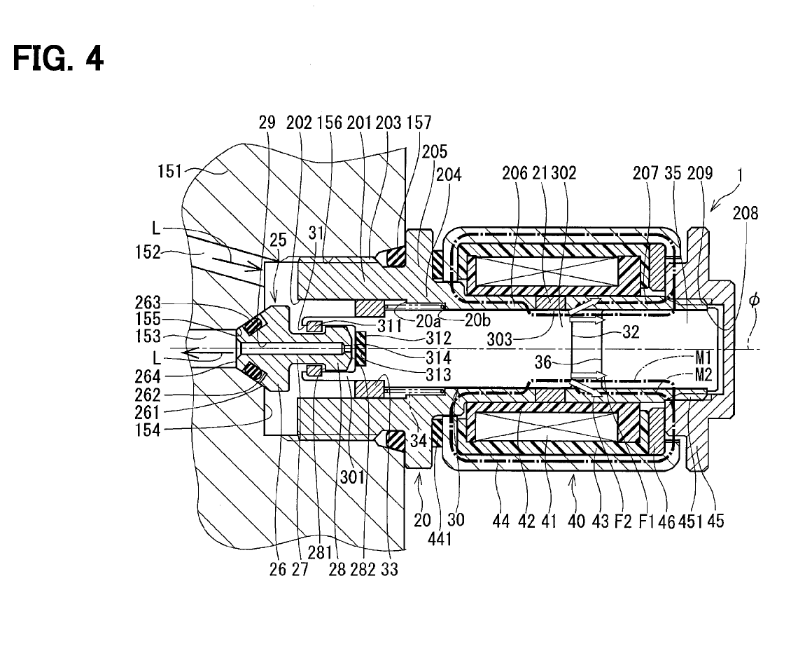

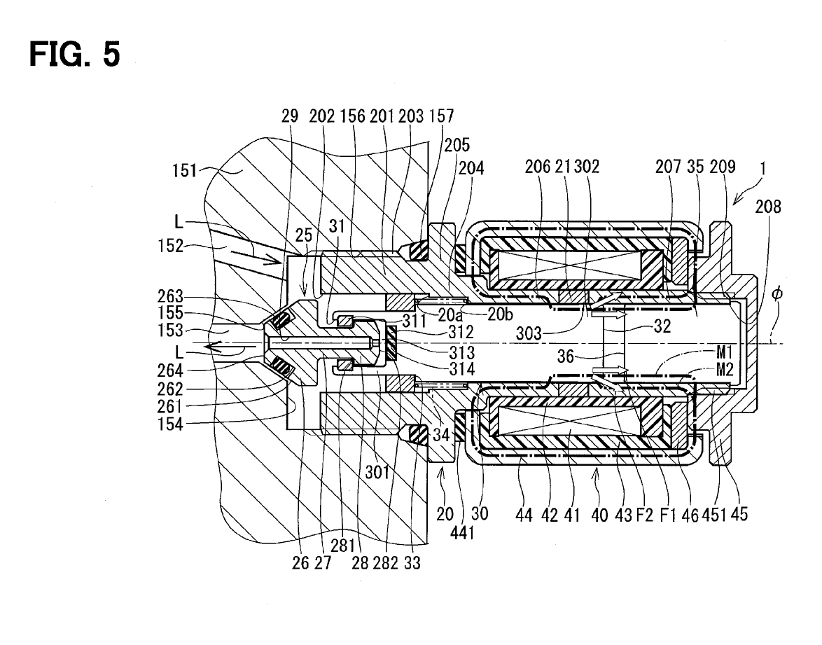

When the current flows through the coil 41, magnetic circuits are generated around the coil 41. A first magnetic circuit M1 is a magnetic circuit of the magnetic circuits as dashed-dotted lines shown in FIGS. 4 and 5. The first magnetic circuit M1 is generated so that a magnetic flux passes from the yoke 44 back to the yoke 44 through the first small-diameter portion 206 of the guide portion 20, the large outer-diameter part 302 of the movable core 30, the end surface 32, the margin surface 36 of the stator core 35, the stator core 35, the second small-diameter portion 207 of the guide portion 20, and the cover portion 45. When the first magnetic circuit M1 is generated, the stator core 35 is excited.

When the current flowing through the coil 41 is small, a magnetic circuit is generated so that the magnetic flux passes from the yoke 44 back to the yoke 44 through the first small-diameter portion 206 of the guide portion 20, the magnetism blocking portion 21, the second small-diameter portion 207 and the cover portion 45. Since the magnetism blocking portion 21 is made of a non-magnetic material modified by the reformulation operation, the magnetism blocking portion 21 is readily magnetically saturated. When the current flowing through the coil 41 is increased, the magnetic circuit becomes a magnetic circuit generated to bypass the magnetism blocking portion 21 so that the magnetic flux passes from the yoke 44 back to the yoke 44 through the first small-diameter portion 206 of the guide portion 20, the large outer-diameter part 302 of the movable core 30, the second small-diameter portion 207 of the guide portion 20 and the cover portion 45. In this case, the magnetism blocking portion 21 blocks the magnetic flux over the whole periphery of a predetermined position of the guide portion 20 in the axial direction of the movable core 30.

When the current flowing through the coil 41 is further increased, an area between the large outer-diameter part 302 of the movable core 30 and the second small-diameter portion 207 is magnetically saturated because the large outer-diameter part 302 and the second small-diameter portion 207 define a gap. Then, a second magnetic circuit M2 is generated from the yoke 44 back to the yoke 44 through the first small-diameter portion 206 of the guide portion 20, the large outer-diameter part 302 of the movable core 30, the end surface 32, the second small-diameter portion 207 of the guide portion 20 and the cover portion 45, as the dashed-dotted lines shown in FIGS.

When the first magnetic circuit M1 is generated, a first magnetic attractive force F1 is generated between the movable core 30 and the stator core 35. The first magnetic attractive force F1 is a magnetic attractive force in a direction parallel to a center axis φ of the guide portion 20 as shown in FIG. 4. When the second magnetic circuit M2 is generated, a second magnetic attractive force F2 is generated between the movable core 30 and the second small-diameter portion 207 of the guide portion 20. The second magnetic attractive force F2 is a magnetic attractive force inclining with respect to the center axis φ of the guide portion 20. According to the present disclosure, the first and second magnetic attractive forces F1 and F2 correspond to a magnetic force.

As the above description, when the current flows through the coil 41, the movable core 30 moves in a direction towards the stator core 35 by canceling the biasing force of the spring 34 according to the magnetic attractive forces F1 and F2. When the movable core 30 moves in the direction towards the stator core 35, the tip surface 282 of the valve member 25 separates from the seal element 312 to define a space 314, as shown in FIG. 4.

The gaseous fuel of high-pressure which has been filled in the concave portion 154 flows into the space 314 between the tip surface 282 of the valve member 25 and the seal element 312 through a gap between the limit member 311 and an outer wall of the small-radius portion 27 of the guide portion 20 and the gap between the inner wall of the concave part 31 of the movable core 30 and an outer wall of the large-radius portion 28 of the valve member 25. The gaseous fuel flowing into the space 314 flows into the outlet passage 153 via the through hole 29. Thus, a difference between the pressure of the gaseous fuel in the concave portion 154 and the pressure of the gaseous fuel in the outlet passage 153 is decreased.

Further, when the movable core 30 moves in the direction towards the stator core 35, the limit member 311 is abutted on the third step side surface 281 of the valve member 25, as shown in FIG. 5. When the movable core 30 further moves in the direction towards the stator core 35, the valve member 25 moves together with the movable core 30 in the direction towards the stator core 35, and the incline surface 261 of the valve member 25 separates from the valve seat 155. Thus, the gaseous fuel of the concave portion 154 flows into the outlet passage 153 via a gap between the valve member 25 and the valve seat 155.

Effects of the electromagnetic valve device 1 according to the first embodiment will be summarized as followings.

(1) In the electromagnetic valve device 1, two magnetic circuits M1 and M2 are generated in a case where the coil 41 is energized. The second magnetic circuit M2 bypassing the magnetism blocking portion 21 is generated to pass through the second small-diameter portion 207 of the guide portion 20, the end surface 32 of the movable core 30, the large outer-diameter part 302 and the first small-diameter portion 206 of the guide portion 20.

In this case, the second magnetic attractive force F2 inclining with respect to the center axis φ of the guide portion 20 is generated between the guide portion 20 and the end part of the large outer-diameter part 302 of the movable core 30. The movable core 30 is moved in the direction towards the stator core 35 according to a part of the second magnetic attractive force F2 parallel to the center axis φ. The movable core 30 is moved in the direction towards the stator core 35 by not only the first magnetic attractive force F1 generated according to the first magnetic circuit M1 but also the second magnetic attractive force F2 generated according to the second magnetic circuit M2.

Thus, in order to generate the same attractive force, a facing area of the end surface 32 of the movable core 30 relative to the margin surface 36 of the stator core 35 can be made small, and a diameter of the movable core 30 can be made small. Thus, a size of the electromagnetic valve device 1 can be made small.

(2) As the above description, since the diameter of the movable core 30 can be made small, the wall thickness of the guide portion 20 having a pressure resistance relative to the gaseous fuel of high-pressure filled in the guide portion 20 can be made relatively thinner.

Specifically, the pressure of the gaseous fuel in the guide portion 20 is referred to as a pressure P, and the unit of the pressure P is Pa. An inner diameter of the guide portion 20 is referred to as an inner diameter D, and the unit of the inner diameter D is m. The wall thickness of the guide portion 20 is referred to as a wall thickness T, and the unit of the wall thickness T is m. A first stress σ1 represents a stress in a direction parallel to the center axis φ, and the unit of the first stress σ1 is N. A second stress σ2 represents a stress in a radial direction, and the unit of the second stress σ2 is N. The relationship between the above parameters is indicated as following formulas.

σ1=(P*D)/(4*T) (i)

σ2=(P*D)/(2*T) (ii)

According to formulas (i) and (ii), when the inner diameter D is increased, the first stress σ1 in the direction parallel to the center φ and the second stress σ2 in the radial direction are increased. Then, it is necessary to increase the wall thickness T. In the electromagnetic valve device 1 according to the first embodiment, the inner diameter is relatively small, so the first stress σ1 and the second stress σ2 are decreased. Thus, the wall thickness T can be made small. Therefore, the size of the electromagnetic valve device 1 can be made further small.

(3) In the electromagnetic valve device 1, the movable core 30 uses a magnetic stainless steel with a high saturated magnetic-flux density as a base material. When the movable core 30 slides in the guide portion 20, the movable core 30 slides on an inner peripheral surface of the guide portion 20 at two positions which are the protrusion part 303 of the movable core 30 and the sliding portion 33 provided at an outer periphery of the movable core 30. Thus, the movable core 30 has both a passing function and a stable function. In the passing function, the magnetic flux passes through the movable core 30 to generate the magnetic circuit. In the stable function, the movable core 30 readily and stably slides in the guide portion 20, because a frictional resistance between the movable core 30 and the guide portion 20 is less than that of when the whole outer peripheral surface of the movable core 30 slides on the inner peripheral surface of the guide portion 20.

Therefore, the valve member 25 can be opened at a small attractive force, and a performance at a low voltage is improved. Thus, the coil assembly 40 can be made small, and the size of the electromagnetic valve device 1 can be made further small.

(4) The plating film having the high abrasion resistance is provided on the outer peripheral surface of the protrusion part 303 and the outer peripheral surface of the sliding portion 33 which slide on the inner peripheral surface of the guide portion 20. Thus, a deformation due to abrasion in a case where the movable core 30 slides can be prevented.

(5) When the valve member 25 is closed, the protrusion part 303 of the movable core 30 is arranged at a position corresponding to the magnetism blocking portion 21 of the guide portion 20. The inner peripheral surface of both the first small-diameter portion 206 and the second small-diameter portion 207, and the outer peripheral surface of the large outer-diameter part 302 define the gap. When the magnetic circuit is generated between the guide portion 20 and the movable core 30, a magnetic attractive force generated in a direction perpendicular to the center axis φ of the guide portion 20 becomes extremely small. In this case, the magnetic attractive force corresponding to a magnetic side force is one of magnetic attractive forces generated between the inner peripheral surface of the first small-diameter portion 206 and the outer peripheral surface of the large outer-diameter part 302 or between the inner peripheral surface of the second small-diameter portion 207 and the outer peripheral surface of the large outer-diameter part 302.

Further, an eccentricity rate of the movable core 30 due to the magnetic attractive force relative to the guide portion 20 becomes small. In this case, the magnetic attractive force is generated in the direction perpendicular to the center axis φ of the guide portion 20. Furthermore, a frictional resistance of when the movable core 30 slides becomes small. Therefore, the valve member 25 can be opened at a small attractive force, and the performance at the low voltage is improved. Thus, the coil assembly 40 can be made small, and the size of the electromagnetic valve device 1 can be made further small.

(6) The entire surface of the end surface 32 of the movable core 30 and the entire surface of the margin surface 36 of the stator core 35 face each other. Therefore, a move facing area can be readily ensured. The move facing area is for generating the first magnetic attractive force F1 between the movable core 30 and the stator core 35 in a case where the coil 41 is energized. Then, the attractive force relative to the movable core 30 of when the valve member 25 is opened is increased, and an inner diameter of the coil 41 for winding coil can be made small. Thus, the coil assembly 40 can be made small, and the size of the electromagnetic valve device 1 can be made further small.

(7) The spring 34 provided between the end surface of the sliding portion 33 close to the large outer-diameter part 302 and the second step side surface 20b of the guide portion 20 separates the sliding portion 33 from the second step side surface 20b of the guide portion 20 and biases the movable core 30 in a direction towards the valve seat 155. Thus, when the magnetic attractive forces F1 and F2 become zero because the current flowing through the coil 41 becomes zero, the movable core 30 is rapidly moved in the direction towards the valve seat 155, and the valve member 25 is abutted on the valve seat 155. Thus, a closing motion of the electromagnetic valve device 1 can be rapidly executed.

(8) When the movable core 30 moves in the direction towards the stator core 35 in the guide portion 20, the end surface of the sliding portion 33 close to the large outer-diameter part 302 is abutted on the first step side surface 20a of the guide portion 20, and a distance of the movable core 30 sliding in the direction towards the stator core 35 is limited. According to the present embodiment, the distance of the movable core 30 corresponds to the moving amount. According to the above configuration, when an end surface of the sliding portion 33 close the large outer-diameter part 302 is abutted on the first step side surface 20a of the guide portion 20, a predetermined clearance is held between the end surface 32 of the movable core 30 and the margin surface 36 of the stator core 35. Thus, when the movable core 30 slides in the guide portion 20 in the axial direction of the movable core 30, a deformation or damage of the movable core 30 due to a collision with the stator core 35 can be prevented.

(9) In an electromagnetic valve device, when the magnetic attractive force becomes zero because the current flowing through the coil 41 becomes zero, and when the end surface of the movable core close to the stator core is abutted on the end surface of the stator core close to the movable core, the magnetic flux is remained, and the movable core can not rapidly separate from the stator core. In the electromagnetic valve device 1, when an end surface of the sliding portion 33 close the large outer-diameter part 302 is abutted on the first step side surface 20a of the guide portion 20, the predetermined clearance is held between the end surface 32 of the movable core 30 and the margin surface 36 of the stator core 35. Therefore, when the magnetic attractive forces become zero because the current flowing through the coil 41 becomes zero, the magnetic flux between the movable core 30 and the stator core 35 is not remained, and the movable core can rapidly separate from the stator core. Thus, the closing motion of the electromagnetic valve device 1 can be further rapidly executed.

(10) The elastic member 441 is provided between the ring portion 205 of the guide portion 20 and the yoke 44 of the coil assembly 40. The elastic member 441 biases the coil assembly 40 in a direction to press the cover portion 45. Therefore, the coil assembly 40 can be stably held between the ring portion 205 of the guide portion 20 and the cover portion 45.

### Second Embodiment

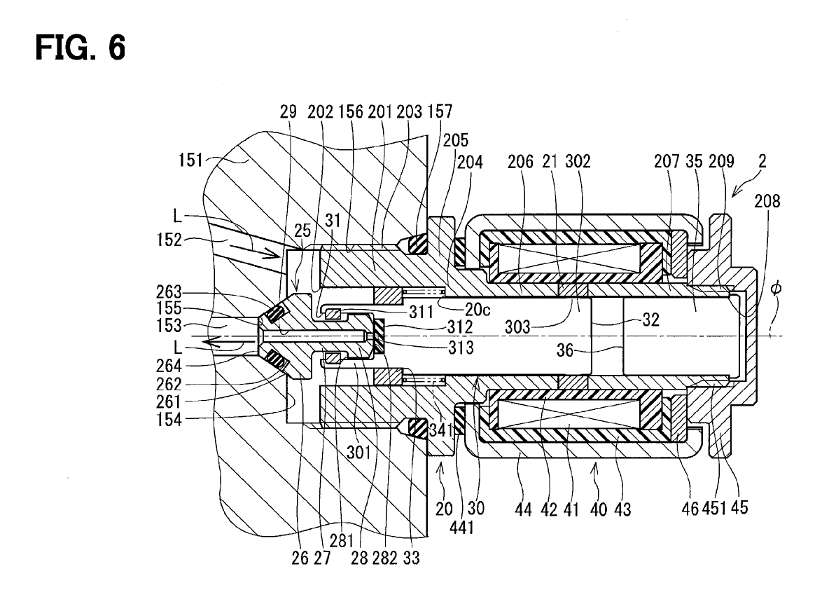

Next, an electromagnetic valve device for the gaseous fuel according to a second embodiment of the present disclosure will be described with reference to FIG. 6. The second embodiment has features different from the first embodiment. Specifically, in the second embodiment, a shape of the guide portion is different from that of the first embodiment. The substantially same parts and the components as the first embodiment are indicated with the same reference numeral and the same description will not be reiterated.

In the electromagnetic valve device 2 according to the second embodiment, the guide portion 20 is constructed by the large-diameter portion 201, the medium-diameter portion 204, the ring portion 205, the first small-diameter portion 206, the magnetism blocking portion 21, and the second small-diameter portion 207, from the support member 151. As shown in FIG. 6, the medium-diameter portion 204 has a first inner diameter equal to the first inner diameter of the large-diameter portion 201 at the area connected with the large-diameter portion 201, and the third inner diameter equal to the third inner diameter of the first small-diameter portion 206 at the area connected with the area of the first inner diameter.

According to the present embodiment, the area of the medium-diameter portion 204 which is connected with the first small-diameter portion 206, the first small-diameter portion 206, the magnetism blocking portion 21 and the second small-diameter portion 207 correspond to the small inner-diameter part. The area of the medium-diameter portion 204 which is connected with the large-diameter portion 201 and the large-diameter portion 201 correspond to the large inner-diameter part.

A fourth step side surface 20c is provided on a border between the inner peripheral surface of the first inner diameter of the medium-diameter portion 204 and an inner peripheral surface of the third inner diameter of the medium-diameter portion 204. According to the present embodiment, the fourth step side surface 20c corresponds to a second step surface.

A spring 341 is provided between the fourth step side surface 20c of the guide portion 20 and the end surface of the sliding portion close to the large outer-diameter part 302. The spring 341 corresponding to a second biasing member functions as the same as the spring 34 of the first embodiment.

When the movable core 30 moves towards the stator core 35, the spring 341 is pressed. When a force moving the movable core 30 towards the stator core 35 matches a biasing force of the spring 341, the spring 341 is the shortest. In this case, the end surface 32 of the movable core 30 is not abutted on the margin surface 36 of the stator core 35. That is, the end surface 32 of the movable core 30 and the margin surface 36 of the stator core 35 define a gap.

As the above description, the electromagnetic valve device 2 according to the second embodiment can accomplish effects (1) to (10) in the first embodiment.

### Third Embodiment

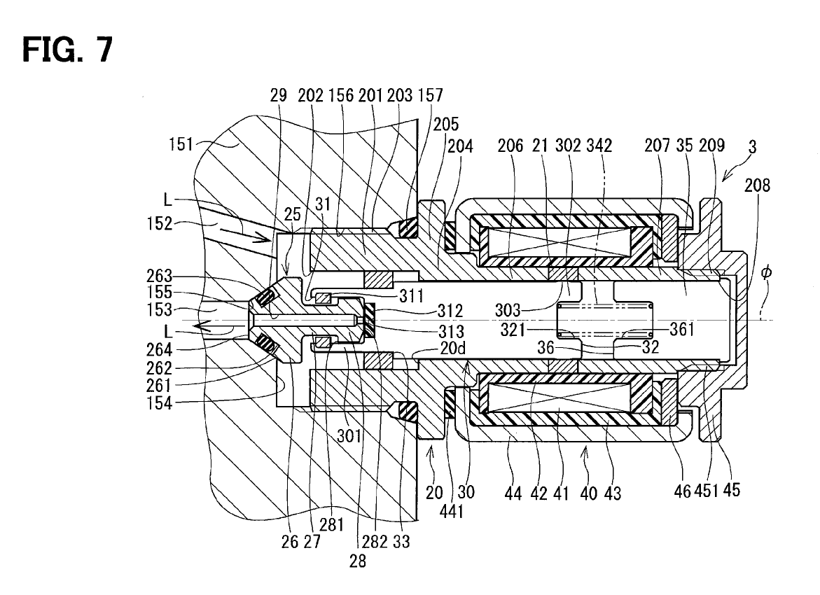

Next, an electromagnetic valve device for the gaseous fuel according to a third embodiment of the present disclosure will be described with reference to FIG. 7. The third embodiment has features different from the second embodiment. Specifically, in the third embodiment, shapes of the guide portion, the movable core and the stator core, and an arrangement of the spring are different from those of the second embodiment. The substantially same parts and the components as the second embodiment are indicated with the same reference numeral and the same description will not be reiterated.

In the electromagnetic valve device 3 according to the third embodiment, as shown in FIG. 7, a depression part 321 is provided on the end surface 32 of the movable core 30. A recess part 361 corresponding to the depression part 321 is provided on the margin surface 36 of the stator core 35.

In the electromagnetic valve device 3 according to the third embodiment, the spring 341 in the second embodiment is not provided. However, a spring 342 corresponding to a first biasing member is provided between a bottom surface of the depression part 321 of the movable core 30 and a bottom surface of the recess part 361 of the stator core 35. The spring 342 functions as the same as the spring 341 in the second embodiment.

Specifically, the spring 342 separates the end surface 32 of the movable core 30 from the margin surface 36 of the stator core 35 and biases the movable core 30 in the direction towards the valve seat 155.

The whole of the medium-diameter portion 204 of the guide portion 20 has a third inner diameter equal to the third inner diameter of the first small-diameter portion 206. A fifth step side surface 20d is provided on a border between the inner peripheral surface of the first inner diameter of the large-diameter portion 201 and the inner peripheral surface of the third inner diameter of the medium-diameter portion 204.

According to the present embodiment, the medium-diameter portion 204, the first small-diameter portion 206, the magnetism blocking portion 21 and the second small-diameter portion 207 correspond to the small inner-diameter part. The large-diameter portion 201 corresponds to the large inner-diameter part. The fifth step side surface 20d corresponds to the first step surface.

When the movable core 30 moves in the direction towards the stator core 35 in the guide portion 20, the end surface of the sliding portion 33 close to the large outer-diameter part 302 is abutted on the fifth step side surface 20d of the guide portion 20, and a distance of the movable core 30 sliding towards the stator core 35 is limited. According to the above configuration, when the end surface of the sliding portion 33 close to the large outer-diameter part 302 is abutted on the fifth step side surface 20d of the guide portion 20, the predetermined clearance is held between the end surface 32 of the movable core 30 and the margin surface 36 of the stator core 35. Thus, when the movable core 30 slides in the guide portion 20 in the axial direction of the movable core 30, the deformation or damage of the movable core 30 due to a collision with the stator core 35 can be prevented.

As the above description, the electromagnetic valve device 3 according to the third embodiment can accomplish effects (1) to (5) and (7) to (10) in the first embodiment.

### Fourth Embodiment

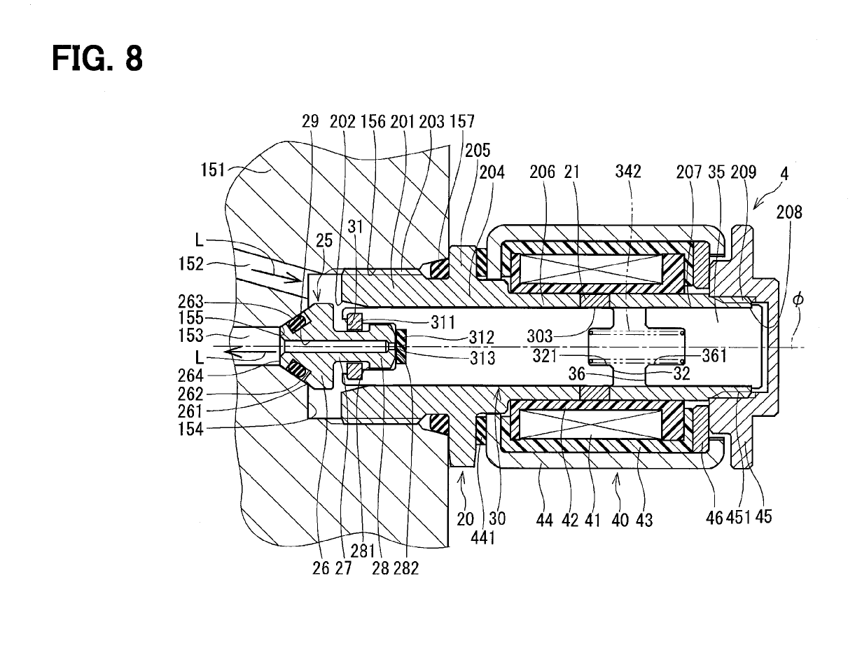

Next, an electromagnetic valve device for the gaseous fuel according to a fourth embodiment of the present disclosure will be described with reference to FIG. 8. The fourth embodiment has features different from the third embodiment. Specifically, in the fourth embodiment, a shape of the guide portion and a shape of the movable core are different from those of the third embodiment. The substantially same parts and the components as the third embodiment are indicated with the same reference numeral and the same description will not be reiterated.

In the electromagnetic valve device 4 according to the fourth embodiment, as shown in FIG. 8, the large-diameter portion 201 of the guide portion 20 and the medium-diameter portion 204 of the guide portion 20 have third inner diameters equal to the third inner diameter of the first small-diameter portion 206. That is, in the guide portion 20, the large-diameter portion 201, the medium-diameter portion 204, the first small-diameter portion 204, the magnetism blocking portion 21 and the second small-diameter portion 207 have the same third inner diameter.

Therefore, the movable core 30 does not have a small-diameter part or a large-diameter part, and has an outer diameter equal to an outer diameter of the large outer-diameter part 302 of the third embodiment. Thus, in the third embodiment, the sliding portion 33 of the second embodiment is canceled.

As the above description, the electromagnetic valve device 4 according to the fourth embodiment can accomplish effects (1) to (5), (7), and (10) in the first embodiment.

### Other Embodiment

(a) According to the above embodiments, the electromagnetic valve device for the gaseous fuel is applied to a gaseous fuel supply system in which the gaseous fuel is supplied to the engine, and blocks or allows the flow of the gaseous fuel. However, the electromagnetic valve device for the gaseous fuel of the present disclosure is not limited to the above system. The electromagnetic valve device for the gaseous fuel may be an electromagnetic valve device that blocks or allows a flow of a high-pressure fluid filled in a guide portion.

(b) According to the above embodiments, the electromagnetic valve device for the gaseous fuel in which the through hole is provided in the valve member is used as a pilot valve to communicate with the inlet passage and the outlet passage via the through hole before the incline surface of the valve member separates from a seat surface. However, the electromagnetic valve device for the gaseous fuel is not limited to the above configuration.

(c) According to the above embodiments, the guide portion and the movable core are made of a magnetic stainless steel including chromium. However, material to form the movable core and the guide portion is not limited. The guide portion and the movable core may be made of a magnetic material.

(d) According to the above embodiments, the magnetism blocking portion of the movable core is made of a non-magnetic material modified by the reformulation operation from a magnetic stainless steel including chromium. However, the magnetism blocking portion may be made of a magnetic stainless steel as the same as the first small-diameter portion and the second small-diameter portion. Further, the magnetism blocking portion is provided to have the wall thickness thinner than that of the first small-diameter portion and the second small-diameter portion. Specifically, the magnetism blocking portion 21 has the third inner diameter equal to the third inner diameter of the first small-diameter portion 206 and the third inner diameter of the second small-diameter portion 207, and has an outer diameter less than the third outer diameter of the first small-diameter portion 206 and the third outer diameter of the second small-diameter portion 207. It is difficult for a magnetic flux generated by energizing a coil to pass through the magnetism blocking portion, and the magnetism blocking portion is readily magnetically saturated.

It is preferable that the magnetism blocking portion has the wall thickness from 0.6 mm to 0.9 mm. However, the wall thickness of the magnetism blocking portion is not limited. The wall thickness of the magnetism blocking portion may be any values as long as the wall thickness is less than that of the first small-diameter portion and the second small-diameter portion.

Further, the magnetism blocking portion of the movable core may combine a non-magnetic feature and a wall-thickness feature. For example, the magnetism blocking portion is provided to be made of non-magnetic and to have the wall thickness less than that of the first small-diameter portion and the second small-diameter portion.

(e) According to the above embodiments, the protrusion part of the movable core is integrally bonded to the small-diameter part and the large-diameter part. However, the protrusion part may be provided as another part different from the small-diameter part or the large-diameter part.

Further, the outer peripheral surface of the protrusion part is arranged at a position so that the outer peripheral surface of the protrusion part can slide on the inner peripheral surface of the magnetism blocking portion. However, a position for arranging the protrusion part is not limited. For example, the outer peripheral surface of the protrusion part may be arranged at a position so that the outer peripheral surface of the protrusion part can slide on not only the inner peripheral surface of the magnetism blocking portion but also the inner peripheral surface of the second small-diameter portion. When the valve member 25 is abutted on the valve seat 155, in other words, when the valve member is closed, the outer peripheral surface of the protrusion part is positioned so that the entire outer peripheral surface of the protrusion part is slidable on the inner peripheral surface of the magnetism blocking portion.

(f) According to the above embodiments, the protrusion part of the movable core is made of a magnetic stainless steel as the same as the small-diameter part and the large-diameter part. However, the protrusion part may be made of a non-magnetic material. In this case, the protrusion part is not limited to be positioned so that the protrusion part is slidable on the inner peripheral surface of the magnetism blocking portion or the inner peripheral surface of the second small-diameter portion. The protrusion part may be positioned so that the protrusion part is slidable on the inner peripheral surface of the first small-diameter portion.

Further, even though the protrusion part is made of a non-magnetic material, the protrusion part is capable of being integrally bonded to the small-diameter part or the large-diameter part by locally modifying a magnetic stainless steel to a non-magnetic material using the reformulation operation.

(g) According to the above embodiments, the protrusion part of the movable core is ring-shaped over the whole periphery of the large-diameter part. However, the protrusion part may be divided into a plurality of parts, which are arranged over the whole periphery of the large-diameter part at a predetermined interval.

(h) According to the above embodiments, the sliding portion is ring-shaped over the whole periphery of the movable core. For example, the sliding portion can be provided over the whole periphery of a small-diameter part of the movable core. However, the sliding portion may be divided into a plurality of parts, which are arranged over the whole periphery of the movable core at a predetermined interval.

(i) According to the above embodiments, the outer peripheral surface of the protrusion part and the outer peripheral surface of the sliding portion which slide on the inner peripheral surface of the guide portion are provided with the plating film having the high abrasion resistance which is made of a non-magnetic material. However, a plating film having the high abrasion resistance, which is made of a magnetic material, may also be used. Further, the plating film itself can be canceled.

(j) According to the above embodiments, the guide portion has chromium from 13 wt % to 17 wt %. However, a chromium content of the guide portion is not limited.

The present disclosure is not limited to the embodiments mentioned above, and can be applied to various embodiments within the spirit and scope of the present disclosure.

What is claimed is:

1. An electromagnetic valve device for a high-pressure fluid, the electromagnetic valve device comprising:
a coil assembly generating a magnetic force when being energized;
a stator core which is made of a magnetic material, and is excited when the coil assembly generates the magnetic force;
a movable core which is made of a magnetic material, and is moved to the stator core when the coil assembly generates the magnetic force;
a guide portion which slidably receives the movable core and is filled with the high-pressure fluid, the guide portion including
a magnetism blocking portion that blocks a magnetic flux over a whole periphery of a predetermined position in an axial direction of the guide portion, and
a magnetism passing portion through which the magnetic flux passes;
a protrusion part which is provided on an outer peripheral surface of the movable core, and slides on an inner peripheral surface of the guide portion in a case where the movable core slides in the guide portion;
a valve member connected with the stator core; and
a seat member forming a valve seat abutting on or separating from the valve member to block or allow the flow of the high-pressure fluid, wherein
a magnetic circuit bypassing the magnetism blocking portion is generated between the magnetism passing portion of the guide portion and the movable core, when the coil assembly generates the magnetic force.

2. The electromagnetic valve device for a high-pressure fluid, according to claim 1, wherein
the magnetism blocking portion has a wall thickness that is less than a wall thickness of the magnetism passing portion.

3. The electromagnetic valve device for a high-pressure fluid, according to claim 1, wherein
the magnetism blocking portion is a part of the guide portion where the predetermined position is modified to a non-magnetic material by a reformulation operation in the axial direction of the guide portion.

4. The electromagnetic valve device for a high-pressure fluid, according to claim 1, wherein the protrusion part is integrally bonded to the movable core.

5. The electromagnetic valve device for a high-pressure fluid, according to claim 1, wherein
the protrusion part is made of a magnetic material and is slidable on an inner peripheral surface of the magnetism blocking portion or an inner peripheral surface of the guide portion closer to the stator core than the magnetism blocking portion.

6. The electromagnetic valve device for a high-pressure fluid, according to claim 1, wherein
the protrusion part is made of a non-magnetic material.

7. The electromagnetic valve device for a high-pressure fluid, according to claim 6, wherein
the protrusion part is modified to a non-magnetic material by a reformulation operation.

8. The electromagnetic valve device for a high-pressure fluid, according to claim 1, wherein
the protrusion part is ring-shaped over a whole periphery of the movable core.

9. The electromagnetic valve device for a high-pressure fluid, according to claim 1, wherein
the protrusion part is divided into a plurality of parts, which are arranged over a whole periphery of the movable core at a predetermined interval.

10. The electromagnetic valve device for a high-pressure fluid, according to claim 1, further comprising
a sliding portion which is made of a non-magnetic material, the sliding portion provided on the outer peripheral surface of the movable core closer to the valve member than the protrusion part, wherein
the guide portion has a small inner-diameter part on which the protrusion part is slidable and a large inner-diameter part on which the sliding portion is slidable, and
the small inner-diameter part has an inner diameter that is less than an inner diameter of the large inner-diameter part.

11. The electromagnetic valve device for a high-pressure fluid, according to claim 10, wherein
the sliding portion is ring-shaped over a whole periphery of the movable core.

12. The electromagnetic valve device for a high-pressure fluid, according to claim 10, wherein
the sliding portion is divided into a plurality of parts, which are arranged over a whole periphery of the movable core at a predetermined interval.

13. The electromagnetic valve device for a high-pressure fluid, according to claim 10, further comprising
a first step surface defined between the small inner-diameter part of the guide portion and the large inner-diameter part of the guide portion and facing an end surface of the sliding portion close to the stator core, wherein
when the movable core slides in the guide portion, the first step surface of the guide portion is abutted on the step surface of the sliding portion to limit a moving amount in an axial direction of the movable core.

14. The electromagnetic valve device for a high-pressure fluid, according to claim 13, wherein
when the movable core is moved to the stator core due to a magnetic force generated by the coil assembly, the movable core and the stator core define a clearance, and the end surface of the sliding portion is abutted on the first step surface of the guide portion.

15. The electromagnetic valve device for a high-pressure fluid, according to claim 1, further comprising
a first biasing member biasing the movable core in a direction towards the valve seat is provided between the movable core and the stator core.

16. The electromagnetic valve device for a high-pressure fluid, according to claim 10, further comprising
a second step surface defined between the small inner-diameter part of the guide portion and the large inner-diameter part of the guide portion; and
a second biasing member provided between the second step surface and the end surface of the sliding portion close to the stator core, to bias the movable core in a direction towards the valve seat.

17. The electromagnetic valve device for a high-pressure fluid, according to claim 10, wherein
the guide portion further includes a medium inner-diameter part between the small inner-diameter part and the large inner-diameter part, and
the medium inner-diameter part has an inner diameter greater than an inner diameter of the small inner-diameter part and less than the inner diameter of the large inner-diameter part, further comprising
a third step surface is defined between the small inner-diameter part and the medium inner-diameter part; and
a third biasing member provide between the third step surface and the end surface of the sliding portion close to the stator core, to bias the movable core in a direction towards the valve seat.

18. The electromagnetic valve device for a high-pressure fluid, according to claim 1, wherein
the protrusion part has a surface that is slidable on the inner peripheral surface of the guide portion and is provided with a plating film having an abrasion resistance.

19. The electromagnetic valve device for a high-pressure fluid, according to claim 10, wherein
the sliding portion has a surface that is slidable on the inner peripheral surface of the guide portion and is provided with a plating film having an abrasion resistance.

20. The electromagnetic valve device for a high-pressure fluid, according to claim 1, wherein
the movable core is made of a magnetic stainless steel.

21. The electromagnetic valve device for a high-pressure fluid, according to claim wherein
the guide portion includes a chromium content from 13 wt % to 17 wt %.
